(19) United States
(12) Patent Application Publication
(10) Pub. No.: US 2005/0273477 A1
(43) Pub. Date: Dec. 8, 2005

(54) Method of discretion of a source attribute of a database

(76) Inventor: Marc Boulle, Tregastel (FR)

Correspondence Address: BRIGGS AND MORGAN P.A., 2200 IDS CENTER, 80 SOUTH 8TH ST, MINNEAPOLIS, MN, 55402, US

(21) Appl. No.: 10/740,078

(22) Filed: Dec. 18, 2003

(30) Foreign Application Priority Data
Dec. 19, 2002 (FR) 02 16733

(51) Int. Cl. G06F 17/30

(52) U.S. Cl. 708/100

(57) ABSTRACT

A method of discretization/grouping of a source attribute or of a source attributes group of a database containing a population of individuals with the object in particular of predicting modalities of a given target attribute. The method includes the steps of: a) partitioning of the modalities of the source attribute or the attributes group into elementary regions, b) evaluating of a merge criterion for each pair of elementary regions, c) searching, among the set of pairs of elementary regions that can be merged, for the pair of elementary regions for which the merge criterion would be optimized, d) skipping directly to step f) as long as the value of a valuation variable of the merge under consideration is not within a predetermined zone of atypical values, e) stopping of the method if there are no elementary regions whose merge would have a consequence of improving said merge criterion, and f) otherwise merging and reiteration of steps b) to e).

### BACKGROUND OF THE INVENTION

This application claims priority to French application number 02016733 filed Dec. 19, 2002.

This invention relates to a method of discretization/grouping of a source attribute or a group of source attributes of a database containing a population of individuals with the object in particular of predicting modalities of a given target attribute. The invention particularly finds application in the statistical handling of data, in particular in the domain of supervised learning.

The statistical analysis of data (also called “data mining”) has gained considerable ground in recent years with the extension of electronic commerce and the appearance of very large databases. Data mining aims in a general way to explore, classify and extract underlying rules of associations within a database. In particular, it is used to construct classification or prediction models. The classification makes it possible to identify, within the database, categories from combinations of attributes, and then to arrange the data as a function of these categories.

In a general way, the values (also called modalities) taken by an attribute may be numeric (for example, a bill of sale) or symbolic (for example, a category of consumption). In the first case we speak of a numeric attribute and in the second case of a symbolic attribute.

Some methods of data mining require a “discretization” of the numeric attributes. By discretization of a numeric attribute we understand here a division of the domain of values taken by an attribute into a finite number of intervals. If the domain in question is a range of continuous values the discretization is expressed by a quantification of this range. If this domain is already made up of discrete ordered values, discretization will have the function of regrouping these values into groups of consecutive values.

The discretization of numeric attributes has been widely treated in the literature. For example, a description of it is found in the work of Zighed et al. under the title “Graphes d'induction” [“Induction Graphs”] published by Hermes Science Publications.

We distinguish two types of discretization methods: descending methods and ascending methods. The descending methods start from the complete interval to be discretized and seek the best cut-off point of the interval by optimizing a predetermined criterion. The ascending methods start from elementary intervals and seek the best merge of two adjacent intervals by optimizing a predeterimined criterion. In both cases, they are applied iteratively until a stopping criterion is satisfied.

### SUMMARY OF THE INVENTION

A method of discretization/grouping of a source attribute or of a source attributes group of a database. This invention relates to a method of discretization/grouping of a source attribute or of a source attributes group of a database containing a population of individuals with the object in particular of predicting modalities of a given target attribute. The method includes the steps of:
a) partitioning of the modalities of the source attribute or the attribute group into elementary regions,
b) evaluating of a merge criterion for each pair of elementary regions,
c) searching, among the set of pairs of elementary regions that can be merged, for the pair of elementary regions for which the merge criterion would be optimized,
d) skipping directly to step f) as long as the value of a valuation variable of the merge under consideration is not within a predetermined zone of atypical values,
e) Stopping of the method if there are no elementary regions whose merge would have the consequence of improving said merge criterion, and
f) otherwise merging and reiteration of steps b) to e).

### BRIEF DESCRIPTION OF THE DRAWINGS

FIG. 1 is a flowchart of the present invention.

### DETAILED DESCRIPTION OF THE PREFERRED EMBODIMENT

This invention relates most particularly to an ascending discretization method based on the global optimization of the χ² criterion.

An ascending discretization method using the χ² criterion is known in the literature under the name ChiMerge. It is described, for example, in the document entitled “Discretization of Numeric Attributes” published in Proceedings Tenth National Conference on Artificial Intelligence, San Jose, Calif., USA, 12-16 July 1992, pages 123-128 under the name of R. Kerbe [internet says R. Kerber].

It is to be recalled in the first place that the χ² criterion makes it possible under certain assumptions to determine the degree of independence of two random variables.

Given S a source attribute and T a target attribute. We will suppose, to fix our ideas, that S presents five modalities a, b, c, d, e and T three modalities A, B, C. Table 1 shows the contingence table of the variables S and T with the following conventions:
nᵢⱼ is the number of individuals observed for the ith modality of the variable S and the j^{th} modality of the variable T. nᵢⱼ is also called the observed effective of the cell (i, j);
nᵢ is the total number of individuals for the i^{th} modality of the variable S. n_{i.} is also called the observed effective of the line i;
nᵢⱼ is the total number of individuals for thej^{th} modality of the variable T. nⱼ is also called the observed effective of the column j;

N is the total number of individuals.

TABLE 1

| S/T | A | B | C | Total |
|---|---|---|---|---|
| a | n₁₁ | n₁₂ | n₁₃ | n_{1.} |
| b | n₂₁ | n₂₂ | n₂₃ | n_{2.} |
| c | n₃₁ | n₃₂ | n₃₃ | n_{3.} |
| d | n₄₁ | n₄₂ | n₄₃ | n_{4.} |
| e | n₅₁ | n₅₂ | n₅₃ | n_{5.} |
| Total | n₁ | n₂ | n₃ | Article I. N |

Generally speaking, we note the number of modalities of the attribute S and the number of modalities of the attribute T as I and J respectively.

We define the theoretical effective eᵢⱼ of the cell (ij) by

$${e}_{ij} = \frac{{n}_{i .} {n}_{. j}}{N} ,$$

representing the number of individuals that would be observed in the cell of the contingence table in the case of independent variables. The deviation from independence of the variable S and T is measured by:

$${χ}^{2} = {\sum }_{i = 1}^{I} {\sum }_{j = 1}^{J} \frac{{( {n}_{ij} - {e}_{ij} )}^{2}}{{e}_{ij}} \qquad ( 1 )$$

The higher the value of χ², the less probable is the assumption of independence of the random variables S and T. We speak with abuse of language of probability of independence of the variables.

More precisely, χ² is a random variable whose density can be shown to follow a fixed law of χ² with (I-1), (J-1) degrees of freedom. The law of χ² is that followed by a quadratic sum of centered normal random values. It has, in fact, the expression of a γ law and tends toward a guassian law when the number of degrees of freedom is high.

For example, if I=5 and J=3, the number of degrees of freedom has the value of 8. If the value of χ² calculated by (1) is 20, the law of χ² with 8 degrees of freedom gives a probability of independence of S and T of 1%.

Having shown that the χ² criterion makes it possible to determine the degree of independence of two random variables, we will now present the ascending discretization method through optimization of the χ² criterion constituted by the method referred to as ChiMerge.

We consider the general case of a source attribute S with I modalities and an attribute T with J modalities. The ChiMerge method considers only two consecutive lines i and i+1 of the contingence table. Let q′₁, q′₂, . . . , q′ⱼ be the local distribution (i.e., in the local context of the consecutive lines i and i+1) of probability of the modalities for the target attribute T. If n_{i.} is the effective of the line i and nᵢ₊₁ is the effective of the line i+1, the observed and theoretical effectives of the line i are expressed respectively by nᵢⱼ=aᵢⱼn_{i.} and eᵢⱼ=q′ⱼn_{i.} where the aᵢⱼ represent the proportions of effectives observed for the line i. In the same way, the observed and theoretical effectives of the line i+1 are expressed respectively by n_{i+1,j}=a_{i+l,j}n_{i+1,.} and e_{i+1,j}=q′ⱼn_{i+1,.} where the a_{i+1,j} represent the observed proportions of modalities of T for the line i+1. The local probability distribution q′₁, q′₂, . . . , q′ⱼ of the modalities of the target attribute may be expressed by:

$${q}_{j}^{′} = \frac{{a}_{ij} {n}_{i .} + {a}_{i + 1 , j} {n}_{i + 1 , .}}{{n}_{i .} + {n}_{i + 1 , .}} \qquad ( 2 )$$

According to the ChiMerge method, we calculate the value of χ² for the lines i and i+1, namely, taking account of the fact that

$${\sum }_{j = 1}^{J} {q}_{j}^{′} = {\sum }_{j = 1}^{J} {a}_{ij} = 1 \text{:} {χ}_{i , i + 1}^{2} = {n}_{i .} ( {\sum }_{j = 1}^{J} \frac{{a}_{ij}^{2}}{{q}_{j}^{′}} - 1 ) + {n}_{i + 1 , .} ( {\sum }_{j = 1}^{J} \frac{{a}_{i + 1 , j}^{2}}{{q}_{j}^{′}} - 1 ) \qquad ( 3 )$$

which further gives after transformation:

$${χ}_{i , i + 1}^{2} = \frac{{n}_{i .} {n}_{i + 1 , .}}{{n}_{i .} + {n}_{i + 1 , .}} {\sum }_{j = 1}^{J} \frac{{( {a}_{ij} - {a}_{i + 1 , j} )}^{2}}{{q}_{j}^{′}} \qquad ( 4 )$$

χ²_{i,i+1} is a random variable following a law of χ² with J−1 degrees of freedom. The ChiMerge method proposes to merge the lines i and i+1 if:
   prob(χ²_{i,i+1},J−1)≦Prob(α,K)=p_{Th} (5)
where prob(α,K) designates the probability that χ²≧α for the law of χ² with K degrees of freedom and p_{Th} is a predetermined threshold value parametrizing the method. In practice, the value prob(α,K) is obtained from a standard table of χ² giving the value of α as a function of prob(α,K) and K.

Condition (5) expresses that the probability of independence of S and T in terms of the two lines considered is less than a threshold value. The merge of consecutive lines is iterated as long as condition (5) is verified. The merge of two lines leads to the regrouping of their modalities and the summation of their effectives. For example, in the case of a numeric attribute with continuous values we have before merge:

TABLE 2

| | | | | | |
|---|---|---|---|---|---|
| [sᵢ, sᵢ₊₁[ | n_{i,1} | n_{i+1,2} | . . . | n_{i,J} | n_{i,.} |
| [sᵢ₊₁, sᵢ₊₂[ | n_{i+1,1} | n_{i+1,2} | . . . | n_{i+1,J} | n_{i+1,.} |

And after merge:

TABLE 3

| | | | | | |
|---|---|---|---|---|---|
| [sᵢ, sᵢ₊₂[ | n_{i,1} + n_{i+1,1} | n_{i+1,2} + n_{i+1,2} | . . . | n_{i,J} + n_{i+1,J} | n_{i,.} + n_{i+1,.} |

In the patent document FR-A-2 825 168 a method is proposed that is a perfecting of the method that has just been described, in particular in that it makes it possible to become free of the problem, in the ChiMerge method, of the choice of the parameter p_{Th}, which must not be too high for fear of merging all lines, nor too low for fear of not merging any pair.

Let us suppose the case of a mono-dimensional numeric attribute S with continuous values. After having ordered the modalities of S, the set of these modalities can be cut up into elementary intervals Sᵢ=[sᵢ,sᵢ₊₁[, i=1, . . . ,I. We wish to evaluate the degree of independence of this attribute with a target attribute T of modalities Tⱼ,j=1, . . . ,J. The contingence table can be represented:

TABLE 4

| S/T | T₁ | T₂ | . . . | T_{J} | Total |
|---|---|---|---|---|---|
| S₁ | n_{1,1} | n_{1,2} | . . . | n_{1,J} | n_{1,.} |
| Λ | Λ | Λ | Λ | Λ | Λ |
| Sᵢ | n_{i,1} | n_{i,2} | . . . | n_{i,J} | n_{i,.} |
| Sᵢ₊₁ | n_{i+1,1} | n_{i+1,2} | . . . | n_{i+1,J} | n_{i+1,.} |
| Λ | Λ | Λ | Λ | Λ | Λ |
| S_{I} | n_{I,1} | n_{I,2} | . . . | Article II. n_{I,J} | n_{I,.} |
| Total | n_{.,1} | n_{.,2} | . . . | n_{.,J} | N |

According to (1), the value of χ² over the set of the table can be expressed by:

$${χ}^{2} = {\sum }_{i = 1}^{I} {\sum }_{j = 1}^{J} \frac{{( {n}_{ij} - {e}_{ij} )}^{2}}{{e}_{ij}} \qquad ( 6 )$$

Also, noting q₁, q₂, . . . , q_{J}, the probability distribution of the modalities of the target attribute, and aᵢⱼ, the proportions of effectives observed for the line i, and observing that

$${e}_{ij} = {q}_{j} {n}_{i , .} , {n}_{ij} = {a}_{ij} {n}_{i , .} and \\ {\sum }_{j = 1}^{J} {q}_{j} = {\sum }_{j = 1}^{J} {a}_{ij} = 1 \text{:} {χ}^{2} = {\sum }_{i = 1}^{I} {n}_{i , .} {\sum }_{j = 1}^{J} ( \frac{{a}_{ij}^{2}}{{q}_{j}} - 1 ) = {\sum }_{i = 1}^{I} {χ}_{( i )}^{2} \qquad ( 7 )$$

where χ²₍ᵢ₎ is the value of χ² for the line i. The expression (7) signifies that χ² is additive with respect to the lines of the table.

After merge of two consecutive lines i and i+1, the value of χ² is modified and the new value, stated as χ²_{f(i,i+1)}, may therefore be written:
χ²_{f(i,i+1)}=χ²+Δχ²_{(i,i+1)} (10)
where Δχ²_{(i,i+1)} is the variation of χ² resulting from the merge of the lines i and i+1. It has been shown that the value of Δχ²_{(i,i+1)} may be calculated explicitly as a function of the proportions of effectives of the lines i and i+1:

$${Δχ}_{( i , i + 1 )}^{2} = - ( \frac{{n}_{i , .} + {n}_{i + 1 , .}}{{n}_{i , .} {n}_{i + 1 , .}} ) {\sum }_{j = 1}^{J} \frac{{( {a}_{ij} - {a}_{i + 1 , j} )}^{2}}{{q}_{j}} \qquad ( 11 )$$

The list of the values of Δχ²_{(i,i+1)} is sorted by decreasing values. For the one presenting the highest value, we test the following inequality of the probabilities of independence of S and T before merge and after merge. We test then if:
prob(χ²_{f(i0,i0+1)},(I−2)(J−1))≦prob(χ², (I−1)(J−1)) (12)

If condition (12) is verified, we merge the lines i₀ and i₀+1. On the other hand, if condition (12) is not verified, then it is not verified for any index i in consequence of the decrease of prob(α,K) as a function of α. The merge process is then stopped.

If the lines i₀ and i₀+1 have been merged, the list of values Δχ²_{(i,i+1)} is updated. It is to be noted that this update in fact concerns only the values relative to the lines contiguous to the lines merged, namely the lines of indices i₀−1 and i₀+2 before merge (if they exist). The merge process is iterated as long as condition (12) is satisfied.

The method that is described in document FR-A-2 825 168 leads to an ad hoc discretization of the domain of the modalities, i.e., to a discretization that minimizes the independence between the source attribute and the target attribute over the set of the domain. As a matter of fact, this discretization method makes it possible to regroup adjacent intervals having similar prediction behaviors with respect to the target attribute, the regrouping being stopped when it harms the quality of prediction, in other words when it no longer decreases the probability of independence of the attributes.

By successive merges we obtain a contingence table, the number of lines of which is reduced, and the effectives per box is increased.

This method nevertheless poses the problem due to a phenomenon referred to as “over-learning”, by which we unduly draw the conclusion of a dependence of the attributes. That corresponds to an improper generalization of characteristics present in the sample studied solely on account of statistical fluctuations. Still in the document FR-A-2 825 168, it was proposed, in order to resolve this problem, to adapt the discretization method described above in the following way: priority is first granted to the merges of lines verifying (12), which makes it possible to verify a minimum effective criterion. The minimum effective criterion can, for example, be written for the line i₀:
e_{i0,j}≧log₂(10N),j=1, . . . ,J (13)

Nevertheless, in spite of the good experimental results obtained, it has turned out that in some cases the minimum effective criterion used above did not offer a sufficient guarantee. In particular, the discretization of independent attributes of the target attribute leads to a discretization into several intervals. That translates into an over-learning, all the more important the higher the size of the learning sample.

Therefore the method that is set forth in the patent document FR-A-2 825 168 does not make it possible to define a “floor” level of the number of intervals corresponding to the independent attributes of the target attribute. The empirical choice of the minimum effective is therefore not satisfactory in the presence of attributes without predictive significance. Moreover, it does not take account of the number and distribution of the target modalities.

Although the preceding introduction relates to a method of discretization of a numeric source attribute, this invention is not limited to such a method. As a matter of fact, the problem that this invention seeks to resolve, which is the problem of “over-learning” mentioned above, is altogether general and also relates to methods of grouping of the modalities of a source attribute when said modalities are not continuous but rather discrete. When the modalities are continuous, they can be partitioned into elementary intervals whereas when they are discrete, they are partitioned into groups. It also relates to methods of discretization or grouping of a source attributes group, for example of the number k, which can then be considered as methods of discretization or grouping in dimension k. Intervals and groups can therefore be of dimension k. In this description, they will subsequently be referred to in a general way as “regions”.

Moreover, although this introduction or the rest of the description considers as merge criterion the χ² criterion (essentially for convenience of description), it is to be understood that this invention is not limited to this particular criterion.

The object of this invention is therefore to propose a perfecting of a method of discretization/grouping of a source attribute or a source attributes group of a database containing a population of individuals with the object in particular of predicting modalities of a given target attribute, which will make it possible to prevent the phenomenon of “over-learning” mentioned above from preventing the detection of attributes without predictive significance.

With this end in view, and in the altogether general case, this invention relates to a method of discretization/grouping of a source attribute or a source attributes group of a database containing a population of individuals with the object, in particular, of predicting modalities of a given target attribute, said method comprising the following steps of:
a) Partition of said modalities of said source attribute or said attribute group into elementary regions,
b) Evaluation of a merge criterion for each pair of elementary regions,
c) Search, among the set of all pairs of elementary regions that can be merged, for the pair of elementary regions for which said merge criterion would be optimized,
e) Stopping of the method if there are no elementary regions the merge of which would have the consequence of improving said merge criterion,
f) otherwise merge and reiteration of steps b) to e).

With a view to resolving the problem mentioned above, this method is characterized in that it comprises in addition a step d) between steps c) and e) that skips directly to step f) as long as the value of a valuation variable of the merge under consideration, said valuation variable characterizing the behavior of said merge criterion, is not included in a predetermined zone of atypical values.

According to another characteristic of this invention, said predetermined zone of atypical values is such that for a target attribute independent of said source attribute or said source attributes group, the value of said merge variable is not included in said zone with a predetermined probability p.

This invention also relates in particular to a method of discretization of a source attribute of a database containing a population of individuals with the object in particular of predicting modalities of a given target attribute, said method comprising the following steps of:
a) Partition of said modalities of the source attribute into adjacent two-by-two elementary intervals,
b) Evaluation for each pair of adjacent elementary intervals of said set, of the value of χ² of the contingence table after a possible merge of said pair,
c) Search, among the set of pairs of elementary intervals that can be merged, of the pair of elementary intervals the merge of which would maximize the value of χ²,
e) Stopping of the method if there are no elementary intervals that make it possible to reduce the probability of independence,
f) otherwise merge and reiteration of steps b) to e).

According to a characteristic of this method, it comprises in addition a step d) between steps c) and e) that skips directly to step f) as long as the value Δχ² of the variation of the value of χ² before and after merge is, in absolute value, less than a predetermined threshold value MaxΔχ².

According to another characteristic of the invention, said predetermined threshold value MaxΔχ² is such that for a target attribute independent of the source attribute the value Δχ² of the variation of the value of χ² before and after merge is always less than said value MaxΔχ² with a predetermined probability p.

According to another characteristic of the invention, said predetermined threshold value MaxΔχ² is equal to the function of χ² of degree of freedom equal to the number J of modalities of the target attribute minus one for a probability p to the power 1/N where N is the size of the sample of the part of the database to which said discretization method is applied:
MaxΔχ²=Invχ²_{J-1}(p^{1/N})
where Invχ² is the function that gives the value of χ² as a function of a given probability p.

According to another characteristic of the invention, said method comprises a step for verification that the effective of a source attribute for modalities in a given interval for each target attribute is greater than a predetermined value, and if such is not the case, to implement the merge of said interval with an adjacent interval.

This invention also relates in particular to a method of grouping of a source attribute of a database containing a population of individuals with the object in particular of predicting modalities of a given target attribute, said method comprising the following steps of:
a) Partition of said modalities of the source attribute into a plurality of groups,
b) Evaluation for each pair of groups of said set, of the value of χ² of the contingence table after a possible merge of said pair,
c) Search, among the set of pairs of groups that can be merged, for the pair of groups the merge of which would maximize the value of χ²,
e) Stopping of the method if there are no merges of groups that make it possible to reduce the probability of independence,
f) otherwise merge and reiteration of steps b) to e).

According to a characteristic of the invention, this method comprises in addition a step d) between steps c) and e) that skips directly to step f) as long as the value Δχ² of the variation of the value of χ² before and after merge is, in absolute value, less than a predetermined threshold value MaxΔχ².

According to another characteristic of the invention, said predetermined threshold value MaxΔχ² is such that for a target attribute independent of the source attribute the value ΔX of the variation of the value of χ² before and after merge is always less than said value MaxΔχ² with a predetermined probability p.

According to another characteristic of the invention, in order to establish the predetermined threshold value MaxΔχ², it consists in using a previously calculated table of values of mean and standard deviation as a function of the number of modalities of the source attribute and of the number of modalities of the target attributes, to determine by linear interpolation from said table of values the mean and standard deviation of MaxΔχ² corresponding to the attributes to be grouped, and then to determine by using the inverse normal law the corresponding predetermined threshold value MaxΔχ², which will not be with a probability p.

According to another characteristic of the invention, for two target modalities, the mean of MaxΔχ² is asymptotically proportional to 2I/π where I is the number of source modalities.

According to another characteristic of the invention, for two source modalities, the law of MaxΔχ² is the law of χ² with J−1 degrees of freedom, J being the number of target modalities.

According to another characteristic of the invention, said method comprises a prior step of verification that the effective of a source attribute for modalities in a given group for each target attribute is greater than a predetermined value, and if such is not the case, to implement a merge of said group with a specific group, said merged group then forming again said specific group.

This invention also relates in particular to a method of discretization in dimension k of a group of k continuous source attributes of a database containing a population of individuals, with the object in particular of predicting the modalities of a given target attribute, said method comprising the following steps of:
a) Partition of said modalities of the group of k source attributes into elementary regions of dimension k,
b) Evaluation for each pair of adjacent elementary regions, of the value of χ² of the contingence table after a possible merge of said pair,
c) Search, among the set of pairs of regions that can be merged, for the pair of regions the merge of which would maximize the value of χ²,
e) Stopping of the method if there is no set of intervals that make it possible to reduce the probability of independence,
f) otherwise merge and reiteration of steps b) to e).

It is characterized in that it comprises in addition a step d) between steps c) and e) that skips directly to step f) as long as the value Δχ² of the variation of the value of χ² before and after merge is, in absolute value, less than a predetermined threshold value MaxΔχ².

Finally, it relates to a method of grouping in dimension k of a group of k discrete source attributes of a database containing a population of individuals, with the object in particular of predicting the modalities of a given target attribute, said method comprising the following steps of:
a) Partition of said modalities of the group of k source attributes into a plurality of groups,
b) Evaluation for each pair of groups of the value of χ² of the contingence table after a possible merge of said pair,
c) Search, among the set of pairs of groups that can be merged, for the pair of groups the merge of which would maximize the value of χ²,
e) Stopping of the method if there are no merges of groups that make it possible to reduce the probability of independence,
f) otherwise reiteration of steps b) to e).

It is then characterized in that it comprises in addition a step d) between steps c) and e) that skips directly to step f) as long as the value Δχ² of the variation of the value of χ² before and after merge is, in absolute value, less than a predetermined threshold value MaxΔχ².

The characteristics of the invention mentioned above, as well as others, will appear more clearly upon reading of the following description of an example of realization, said description being done with relation to Fig. unique is a flowchart showing the various steps implemented by the method of discretization or a method of grouping according to this invention.

As already mentioned above, this description will, for reasons of convenience, consider as:
merge criterion, the χ² criterion, improvement of the merge criterion, the reduction of the probability of independence, valuation variable of a merge, the value of the variation Δχ² of the value of χ² before and after said merge, zone of atypical values, the values of the variation Δχ² greater than a predetermined threshold value MaxΔχ².

But it is to be understood that this invention is not limited to these particular cases.

At first, we will consider, in this limiting context set forth above, a method of discretization of a source attribute such as the one that is described in the patent document FR-A-2 825 168. In this document, we consider all possible merges of intervals, we choose the best merge, and if the stopping criterion is not attained, we carry out this merge and continue.

According to this mode of realization of this invention, we will in the same way study the law of Δχ²_{i,I+1} (variation of the value of χ² at the time of the merge of two intervals i and i+1). At the time of the unfolding of the method a large number of merges are considered, and at each step we choose the best of all these merges by optimizing the χ² criterion, or, which is equivalent, by optimizing the Δχ² criterion (the starting χ² being fixed) in a way equivalent to that described in the document mentioned above. In addition to a stopping condition on the probabilities of independence between source attribute and target attribute before and after, the method according to this invention provides for the continuation of the merges as long as the value of Δχ²_{i0,i0+1} is not sufficiently large (It is to be recalled here that i0 and i0+1, respectively, are the indices of the intervals whose value of Δχ²_{i0,i0+1} is the highest).

In other words, we will carry out a test on this highest value of Δχ²_{i0,i0+1}, or more exactly its absolute value, by comparing it with a maximal value designated MaxΔχ². If this absolute value of Δχ²_{i0,i0+1} is less than the value MaxΔχ², then the process of merge of the intervals is forced no matter what (not knowing the other stopping conditions).

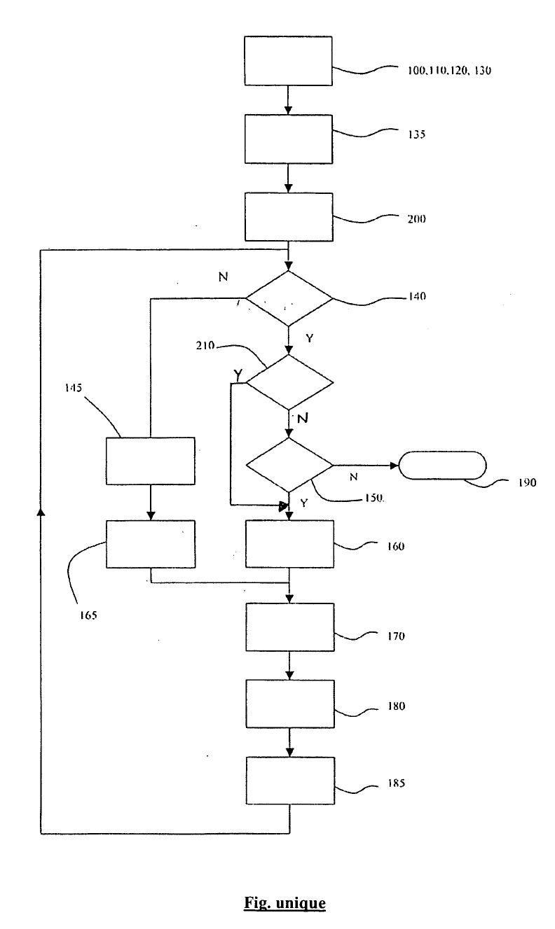

A flowchart of an example of implementation of a method of discretization according to this invention is represented in FIG. 1.

The algorithm begins with an initialization phase 100, 110, 120, 130 (the references are identical to those used in the patent document FR-A-2 825 168 wherein we carry out a partition of the domain of the modalities of the source attribute into ordered elementary intervals (step 100), we calculate the value of the resultant χ² as well as the values χ²₍ᵢ₎ for the I lines of the contingence table (step 110), we calculate the values Δχ²_{(i,i+1)} of the values χ²₍ᵢ₎ (step 120) and we sort these values Δχ²_{(i,i+1)} by decreasing values (step 130).

It is to be noted that the first value Δχ²_{i0,i0+1} is the one that is the highest in relative value, but as the values Δχ²_{(i,i+1)} are always negative, it is the one whose absolute value is the lowest. This value corresponds to the merge of two adjacent intervals with indices i0 and i0+1 for which the absolute value of Δχ²_{i0,i0+1} is minimized or for which the value of χ²_{f(i0,i0+1)} after merge of the intervals i0 and i0+1 is maximized.

In step 200, a step that is new with respect to what is described in document FR-A-2 825 168, we initialize the value MaxΔχ². It could be a matter of a constant value taken once and for all. Nevertheless, as we will see later on, this value depends on the data to be treated so that at step 200, it is a calculation that is carried out.

In step 140, we test whether the minimum effective condition in each cell of the contingence table is verified. It may be a matter of verifying that each cell of the table comprises an effective minimum in order that the process of this invention may function correctly while being placed under the application conditions of the χ² test. It is to be understood that it is not a question here, as was the case in the patent document FR-A-2 825 168 mentioned above, of resolving the problem of over-learning. Again employing the notations above, it is a matter here of verifying that:
nᵢⱼ>nₘᵢₙ for all i and j
where nₘᵢₙ is the minimum effective number. This number is, for example, 5.

In the case in which the preceding relation is verified, we pass directly to test 210. In the negative, we proceed by step 145.

In step 145, we give priority to the pairs of intervals for which at least one among them has a cell that hasn't attained the minimum effective nₘᵢₙ and in step 165 we select among them the pair of intervals (i₀,i₀+1) for which the value Δχ²_{i0,i0+1} is the highest. We then proceed to step 170.

In step 210, a step that is new with respect to what was described in document FR-A-2 825 168, we test whether the highest absolute value of Δχ²_{i0,i0}+1 is less than the maximal value designated MaxΔχ² determined in step 200. If this absolute value of Δχ²_{i0,i0+1} is less than the value MaxΔχ², we then proceed to step 160, otherwise we go to step 150.

In step 150, we consider the intervals i0 and i0+1 for which the value Δχ²_{i0,i0+1} is the highest and we test whether the probability of independence between source attribute and target attribute after merge of these two intervals, designated prob(χ²_{f(i0,i0+1)},(I−2)(J−1)), is less than or equal to the probability of independence between source attribute and target attribute before merge of the two intervals. We therefore test the following relation:
prob(χ²_{f(i0,i0+1)},(I−2)(J−1))≦prob(χ²,(I−1)(J−1))

If such is the case, we select (step 160) the pair of intervals i0 and i0+1 as being to be merged and we proceed to step 170. On the other hand, if such is not the case, the process is ended at 190.

In step 170, the intervals of index i0 and i0+1 are merged. The new value of χ²₍ᵢ₀₎ is then calculated in 180 as well as the new values of Δχ²_{(i0-1,i0)} and Δχ²_{(i0,i0+1)} for the adjacent intervals, if they exist. In 185, the list of the values Δχ²_{(i,i+1)} is updated: the old values Δχ²_{(i0-1,i0)} and Δχ²_{(i0,i0+1)} are deleted and the new values are stored. The list of the values Δχ²_{(i,i+1)} is advantageously organized in the form of a binary tree of balanced search that makes it possible to manage the insertions/deletions while maintaining the relation of order in the list. Thus it is not necessary to completely sort the list at each step. The list of flags is also updated. After the update, the process returns to the test step 140.

We describe below modes of realization of means that make it possible to determine the value of MaxΔχ². It is to be understood that these means are implemented in the box 200 of FIG. 1.

In order to do this, we will start from the observation that, for a source attribute and a target attribute that are independent, the desired result is that at the conclusion of the process of discretization, only a single interval remains any longer, signifying in this way that the source attribute (taken separately) does not contain any information on the target attribute. In this case, we can for a given probability p determine a value MaxΔχ²(p) that will not be exceeded with a probability p.

Thus, in step 200, we determine MaxΔχ² as being equal to MaxΔχ²(p), with p a probability whose value is predetermined.

In this way we ensure in this way the desired behavior with a probability p. In the case of any two attributes (not necessarily independent), this way of making the method reliable makes it possible for us to assert that if the algorithm produces a discretization containing information (at least two intervals), there is a probability greater than p that the descriptive attribute is really the carrier of information about the attribute to be predicted.

We sought to theoretically determine the relation that exists between the value of MaxΔχ² and the probability p. In order to do this, we studied the law of Delta Δχ²_{(i,i+1)} (variation of the value of χ² at the time of the merge of two intervals of rank i and i+1) in the case of two independent attributes. In this case, it is necessary to continue the merges until there no longer remains but a single final group, which is in fact the initial sample. It is therefore necessary that the largest value Δχ²_{(i0,i0+1)} encountered during the process be accepted. We will try to estimate this largest value during the unfolding of the discretization process, and impose that the merges be continued as long as this threshold is not attained, which will therefore be the sought-for value of MaxΔχ².

For two independent attributes, the value of χ² follows a law of probability whose expectation and variance are linked in the following way:
E(χ²)=k

$$Var ( {χ}^{2} ) = 2 k + \frac{1}{N} ( \sum 1 / {q}_{i} - {k}^{2} - 4 k - 1 )$$

We have also been able to show (see previously, relation 11) that the induced variation of χ² following the merge of two intervals of respective effectives n and n′ and of proportions of target local modalities respectively equal to pⱼ and p′ⱼ can be written in the form:

$${Δχ}^{2} = {χ}_{after\_merge}^{2} - {χ}_{before\_merge}^{2} = - ( \frac{n {n}^{′}}{n + {n}^{′}} ) {\sum }_{j = 1}^{J} \frac{{( {p}_{j} - {p}_{j}^{′} )}^{2}}{{P}_{j}}$$

Pⱼ is the global proportion of modalities of the target attribute of rank j.

It is known that this variation is always negative, and is zero only if the intervals are identical or have exactly the same proportions of target modalities. Thus, it is known that χ² of a contingence table can only decrease following the merge of two lines of the contingence table. Afterwards, we redefine Δχ² by its absolute value in order to manipulate only positive magnitudes.

$${Δχ}^{2} = \frac{{nn}^{′}}{n + {n}^{′}} {\sum }_{j = 1}^{J} \frac{{( {p}_{j} - {p}_{j}^{′} )}^{2}}{{P}_{j}}$$

The calculation of the distribution function of Δχ² is based on discrete binomial laws, which makes it difficult to evaluate for large values of n. We will use the central limit theorem to approximate the law of Δχ² in the case where n=n′.

We make the following proposition: for a source attribute independent of a target attribute with J modalities, Δχ² resulting from the merge of two intervals of the same effective n and n′ asymptotically follows a law of χ² with J−1 degrees of freedom.

We have been able to show that this proposition is not only valid in the case of two target modalities but also in other cases.

We observe that the law of Δχ² depends on the number of modalities of the target attribute, but not on their distribution.

We will now evaluate the statistics of the merges of the method according to this invention.

We observe first that at the time of a “total” discretization up to a single final interval, the number of merges carried out is approximately equal to the size N of the sample.

We will at first experimentally evaluate the real behavior of the algorithm and thus this simple statistical modeling of the method of this invention. The experimentation consists in implementing the method of the invention on a sample comprising a continuous source attribute independent of the target attribute and taking equi-distributed Boolean values. We carry out all possible merges up to the point of obtaining a unique terminal interval (the stopping criteria are made inactive) and we collect the value of Δχ² of each of these merges in order to plot the distribution function from them. We carry out this experimentation on samples of size 100, 1,000 and 10,000, and then we compare the distribution functions obtained with the theoretical distribution function of Δχ² of two intervals of the same effectives (law of χ² with one degree of freedom).

This experimentation shows that the law of the Δχ²'s resulting from the various merges carried out at the time of the implementation of the method of the invention does not depend on the size of the sample, and is well modeled by the theoretical law of Δχ² demonstrated above for two intervals of the same effective. According to a mode of realization of this invention, a threshold MaxΔχ² for the implementation of the above method is such that for two independent source and target attributes, the method converges toward a single terminal group with a probability greater than p (p=0.95 for example). It is therefore necessary that all merges considered be accepted, i.e., that all the values of Δχ² resulting from the merges considered be less than the threshold MaxΔχ². By being based on the preceding modeling wherein all merges are independent, the probability that all merges considered are accepted is equal to the probability that one merge is accepted to the power N. We therefore seek MaxΔχ² such that:
P(Δχ²_{J}≦MaXΔχ²)^{N}≧p

Proceeding by the equivalent law of χ², we have:
P(χ²_{J-1}≦MaxΔχ²)≧p^{1/N}

Which can also be written:
MaxΔχ²=Invχ²_{J-1}(p^{1/N})
where Invχ² is the function which gives the value of χ² as a function of a given probability p.

We sought to validate this modeling of the law of MaxΔχ². In order to do so, we were interested this time not in the distribution of the values of Δχ² during the implementation of the method of the invention, but in the maxima of these values. For that, we use samples of two really independent source and target attributes as previously and we collect, for a large number of samples for discretization, the maximal value of the Δχ²'s resulting from the merges of intervals effected. We carry out this experimentation 1000 times for samples of size 100, 1,000 and 10,000 and 100,000 and we plot the “empirical” distribution functions of MaxΔχ² for each of these interval sizes. We also plot the theoretical distribution functions obtained with the above formula on the same figures.

We observed that the empirical laws and the corresponding theoretical laws have very similar forms, whatever the size of the sample. We also observed that the theoretical values constitute an upper limit of the empirical values. Consequently, this limit constitutes a sufficiently faithful estimation of the empirical values. It is to be noted that although resting on reasonable bases, its behavior as upper limit could be verified only experimentally.

We carried out experimentations that make it possible to evaluate this invention in its first particular mode of realization.

In a first experimentation, we discretized a continuous source attribute independent of a target attribute to be predicted, for sample sizes of 100, 1,000, 10,000, 100,000 and 100,000 [sic]. For each sample size, we repeated this experimentation 1,000 times. We count the number of cases in which the discretization leads to a unique terminal interval, and in the contrary cases of multi-interval discretization, we calculate the mean value of the number of intervals. The results of this first experimentation are shown in the table below.

| | | Multi-interval |
|---|---|---|
| | % without | discretization |
| Sample size | discretization | Number of intervals |
| 100 | 98.6% | 2.36 |
| 1,000 | 98.7% | 3.00 |
| 10,000 | 98.4% | 3.00 |
| 100,000 | 97.2% | 3.00 |
| 1,000,000 | 95.6% | 3.00 |

It can be noted that the discretization of an attribute independent of the target attribute leads in 95% to 98% of the cases to a unique terminal interval. It can be concluded, on the basis of this experimentation, that the method according to this invention behaves in a way in keeping with what is expected, at least in the domain of sample sizes varying from 100 to 1,000,000.

We will show below that the method that has just been described in relation to FIG. 1 is not only applicable to the problem of discretization of numeric data as shown above but also to the problem of grouping of the modalities of symbolic attributes.

It is to be recalled that the problem of the grouping of the modalities of a symbolic attribute consists in partitioning the set of values of the attribute into a finite number of groups, each identified by a code. Thus, most of the predictive models based on a decision tree use a grouping method to treat symbolic attributes, in such a way as to combat fragmentation of the data.

The management of the modalities of a symbolic variable is a more general problem the stakes of which amply exceed the bounds of decision trees. For example, the methods based on neuron networks using only numeric data often resort to a complete disjunctive coding of the symbolic variables. In the case in which the modalities are too numerous, it is necessary, as a preliminary, to conduct groupings of modalities. This problem is also encountered in the case of Bayesian networks.

At stake in the regrouping of modalities is the finding of a partition realizing a compromise between informational quality (groups homogeneous with respect to the source attribute to be predicted) and statistical quality (sufficient effectives to ensure an effective generalization). Thus, the extreme case of an attribute having as many modalities as individuals is unusable: any regrouping of the modalities corresponds to a learning “by heart” that is unusable in generalization. In the other extreme case of an attribute possessing a single modality, the capacity for generalization is optimal, but the attribute does not possess any information that would make it possible to separate the classes to be predicted. It is then a matter of finding a mathematical criterion that makes it possible to evaluate and compare partitions of different sizes, and an algorithm that leads to finding the best partition.

The grouping method according to this invention uses the global value of χ² of the table of contingence between discretized attribute (source attribute) and attribute to be predicted (target attribute), and seeks to minimize the corresponding probability of independence P. The grouping method begins with the partitioning of the initial modalities and then evaluates all possible merges and finally chooses the one that maximizes the criterion of χ² applied to the new partition that was formed. The method stops automatically as soon as the probability of independence P no longer decreases. This part of the method is identical to the one that is described in document FR-A-2 825 168. Moreover, the grouping method according to this invention is similar to the discretization method described above while bringing to it the same perfection. It makes possible a real control of the predictive quality of a grouping of modalities.

Like the discretization method described above, it rests on the study of the statistical behavior of the algorithm in the presence of a symbolic attribute independent of the attribute to be predicted. We therefore studied the statistics of the maximal variation of the χ² criterion at the time of the complete unfolding of the grouping algorithm. This study showed that this maximal value MaxΔχ² depends only on the number of modalities of the source and target attributes and is insensitive to the distribution of these modalities as well as to the size of the learning sample. With reference to the modeling of the statistics of MaxΔχ², we then modified the initial grouping algorithm by constraining it to accept any merge of modalities that leads to a variation of χ² less than the calculated maximal theoretical variation MaxΔχ².

This invention makes it possible to guarantee, on the one hand, that the modality groupings of an attribute independent of the attribute to be predicted leads to a single terminal group and, on the other hand, that the groupings leading to several groups correspond to attributes having a real predictive significance. Experimentations confirm the significance of this robust version of the algorithm and show good predictive performances for the groupings obtained.

The discretization method described previously can be generalized to grouping by replacing the intervals by groups of modalities and by replacing the search for the best merge of adjacent intervals by the search for the best merge of any groups.

The minimum effective constraint is expressed here by a minimum effective per modality. At the time of a pre-treatment, any source modality not attaining this minimum effective will be unconditionally grouped in another special modality provided for this purpose. Thus, there remain then only modalities that satisfy the minimum effective constraint entering into the grouping method.

In a manner analogous to the discretization method previously described, it is possible to reduce the grouping algorithm to an algorithmic complexity of Nlog(N)+J²log(J) where N is the number of individuals in the sample and J is the number of modalities of the source attribute (once the other special modality is treated).

The flowchart of the grouping method according to this invention is identical to that of the discretization method described above in relation to FIG. 2.

We will now seek to express the value of MaxΔχ² in the context of a grouping method.

At the time of the implementation of the grouping method according to the invention as illustrated in FIG. 2, we consider all possible merges of lines of the contingence table and we choose the one that maximizes the χ² value of the contingence table after merge of the lines, i.e., the one that maximizes the Δχ² variation during the merge.

We consider that the value MaxΔχ² is the maximal value of Δχ² that will be attained at the time of the implementation of the method according to this invention, the value obtained at the time of the attainment of a unique terminal group of modalities.

Thus, the basic principle of the method of this invention is to establish that for a source attribute independent of the attribute to be predicted, we will naturally observe variations of Δχ² and therefore a MaxΔχ² due to the chance of the sample. But in short, the grouping of the modalities of an attribute independent of the attribute to be predicted should lead to a single terminal group. Consequently, we impose that any group merge leading to a χ² variation less than the variations that can be due to chance (i.e., less than MaxΔχ²) is automatically accepted. In this way we also ensure that any grouping leading to at least two terminal groups corresponds to an attribute not independent of the attribute to be predicted.

We will now seek to establish the statistics of MaxΔχ² in the case of the treatment of the grouping of modalities of attributes.

Let N be the size of the sample, I the number of source modalities and J the number of target modalities.

It is to be noted that, for reasons already explained above, we consider the case wherein the minimum effective constraint of 5 per cell of the contingence table is respected, in such a way as to be able to validly use the χ² statistics.

A priori, the MaxΔχ² statistics depend on the size of the sample N, on the number of modalities of the source attribute I, on the number of modalities of the attribute J, but also on the distribution of the frequencies of the source modalities and on the distribution of the frequencies of the target modalities.

In fact, we demonstrated that the MaxΔχ² law depends in reality only on the number of modalities of the source attribute I and of the target attribute J. We also demonstrated that for 2 source modalities, the MaxΔχ² law is the law of χ² with J−1 degrees of freedom. Its mean is therefore J−1.

Moreover, for 2 target modalities, we also demonstrated that the mean of MaxΔχ² is asymptotically proportional to 2I/π.

We have described up to now a method of discretization of a source attribute whose continuous modalities are mono-dimensional but it is to be understood that this invention is also applicable to a method of discretization of a source attribute whose equally continuous modalities are of dimensions k.

In this case, the source attribute is a numeric source attribute of dimensions k formed by k mono-dimensional source attributes. Each individual of the population may be represented by a point of the space of said attributes of dimension k.

This method of discretization in dimension k of a group of k source attributes therefore consists in doing a partition of the modalities of the group of the k source attributes into elementary regions of dimension k and an evaluation for each pair of adjacent elementary regions of the value of χ² of the contingence table after a possible merge of said pair.

It is to be noted that the elementary regions in question are, for example, Voronoi cells of the space of the source attributes. In order to find two adjacent elementary regions, we construct the Delaunay graph associated with the Voronof cells and we eliminate from this graph any arc joining two neighboring cells by passing through a third, the pairs of adjacent regions being given by the arcs of the Delaunay graph after the elimination step.

Patent document FR-A-2 825 168 can profitably be referred to for details concerning these steps of partition and evaluation.

Next we carry out the merge, among the set of pairs of regions that can be merged, of the pair of regions the merge of which maximizes the value of χ² and we stop the method when there is no set of intervals that make it possible to reduce the probability of independence. If such is not the case, we reiterate the preceding steps.

According to a characteristic of this invention, the method of discretization in dimension k of a group of k source attributes is characterized in that it comprises in addition a step that skips directly from the merge step after the stopping step as long as the value Δχ² of the variation of the value of χ² before and after merge is, in absolute value, less than a predetermined threshold value MaxΔχ².

In the same way, the method which has just been described is also applicable to the grouping in dimension k of a group of k discrete source attributes. As previously, it then consists in doing a partition of said modalities of the group of k source attributes into a plurality of groups and an evaluation for each pair of groups of the value of χ² of the contingence table after a possible merge of said pair.

It consists in doing the merge, among the set of pairs of groups that can be merged, of the pair of groups the merge of which maximizes the value of χ² and in stopping the method if there are no merges of groups that make it possible to reduce the probability of independence, otherwise we reiterate the preceding steps.

This grouping method comprises in addition a step that skips directly to the reiteration step as long as the value Δχ² of the variation of the value of χ² before and after merge is, in absolute value, less than a predetermined threshold value MaxΔχ².

It is to be recalled that in an altogether general way, this invention relates to a method of discretization/grouping of a source attribute or of a source attributes group of a database containing a population of individuals with the object in particular of predicting modalities of a given target attribute.

If we refer to Fig. unique, the steps of partition of said modalities of said source attribute or of said attribute group into elementary regions, of evaluation for each pair of elementary regions of the value, after a possible merge of said pair, of a merge criterion, and of search, among the set of pairs of elementary regions that can be merged, for the pair of elementary regions for which the merge criterion would be optimized corresponding to steps 100, 110, 120 and 130.

The stopping step of the method if there are no elementary regions whose merge would have the consequence of improving the merge criterion is step 150.

The merge and reiteration step is represented by the loop including 160, 170, 180 and 185.

The step that skips directly as long as the value of the valuation variable of the merge is not included in a predetermined zone of atypical values is step 210.

Finally, the determination step of the predetermined zone of atypical values is step 200.

1-14. (canceled)

15. A method of discretization/grouping of a source attribute or a source attributes group of a database containing a population of individuals with the object in particular of predicting modalities of a given target attribute, said method comprising the following steps of:
(a) partitioning of said modalities of said source attribute or said attributes group into elementary regions,
(b) evaluating of a merge criterion for each pair of elementary regions,
(c) searching, among the set of pairs of elementary regions that can be merged, for the pair of elementary regions for which the merge criterion would be optimized,
(d) skipping to step f) as long as the value of a valuation variable of the merge under consideration, said valuation variable characterizing the behavior of said merge criterion, is not within a predetermined zone of atypical values,
(e) stopping the method if there are no elementary regions whose merge would have a consequence of improving said merge criterion, and
(f) otherwise merging and reiterating of steps b) to e).

16. A method of discretization/grouping of a source attribute or source attributes group according to claim 1, wherein said predetermined zone of atypical values is such that for a target attribute independent of said source attribute or said source attributes group, the value of said valuation variable of the merge under consideration is not within said zone with a predetermined probability p.

17. A method of discretization of a source attribute of a database containing a population of individuals with the object in particular of predicting modalities of a given target attribute, said method comprising the following steps of:
(a) partitioning of said modalities of the source attribute into adjacent two-by-two elementary intervals.
(b) evaluating for each pair of adjacent elementary intervals of said set of the value of χ² of a contingence table after a possible merge of said pair,
(c) searching, among the set of pairs of elementary intervals that can be merged, for the pair of elementary intervals whose merge would maximize the value of χ²,
(d) skipping directly to step f) as long as the value Δχ² of the variation of the value of χ² before and after merge is, in absolute value, less than a predetermined threshold value MaxΔχ²,
(e) stopping of the method if there are no elementary intervals that make it possible to reduce a probability of independence, and
(f) otherwise merging and reiterating of steps b) to e).

18. A discretization method according to claim 17, wherein said predetermined threshold value MaxΔχ² is such that for a target attribute independent of the source attribute the value Δχ² of the variation of the value of χ² before and after merge is always less than said value MaxΔχ² with a predetermined probability p.

19. A discretization method according to claim 18, wherein said predetermined threshold value MaxΔχ² is equal to the function of χ² of degree of freedom equal to the number J of modalities of the target attribute minus one for a second probability p to the power 1/N where N is the size of the sample of the part of the database to which said discretization method is applied:
MaxΔχ²=Invχ²_{J-1}(p^{1/N})
where Invχ² is the function that gives the value of χ² as a function of a given probability p.

20. A method of discretization of a source attribute according to claim 19, further comprising a step of verification that the effectiveness of the source attribute for modalities in a given interval for each target attribute is greater than the predetermined value, and if such is not the case, to implement the merge of said interval with an adjacent interval.

21. A method of grouping of a source attribute of a database containing a population of individuals with the object in particular of predicting modalities of a given target attribute, said method comprising the following steps of:
(a) partitioning of said modalities of the source attribute into a plurality of groups,
(b) evaluating for each plurality of groups of said set of the value of χ² of a contingence table after a possible merge of said plurality of groups,
(c) searching among the set of plurality of groups that can be merged for the groups whose merge would maximize the value of χ²,
(d) skipping directly to step f) as long as the value Δχ² of the variation of the value of χ² before and after merge is, in absolute value, less than a predetermined threshold value MaxΔχ²,
(e) stopping of the method if there are no merges of groups that make it possible to reduce a probability of independence, and
(f) otherwise merging and reiteration of steps b) to e).

22. A grouping method according to claim 21, wherein said predetermined threshold value MaxΔχ² is such that for a target attribute independent of the source attribute the value Δχ² of the variation of the value of χ² before and after merge is always less than said value MaxΔχ² with a predetermined probability p.

23. A grouping method according to claim 22, wherein establishing the predetermined threshold value MaxΔχ² consists in using a previously calculated table of values of mean and standard deviation as a function of the number of modalities of the source attribute and of the number of modalities of the target attributes to determine by linear interpolation from said table of values the mean and standard deviation of MaxΔχ² corresponding to the attributes to be grouped, and then to determine, by using the inverse normal law, the corresponding predetermined threshold value MaxΔχ² which will not be with the probability p.

24. A grouping method according to claim 23, wherein for two target modalities, the mean of MaxΔχ² is asymptotically proportional to 2I/π, where I is the number of the source modalities.

25. A grouping method according to claim 24, wherein for two source modalities, the law of MaxΔχ² is the law of χ² with J−1 degrees of freedom, J being the number of target modalities.

26. A method of grouping of a source attribute according to claim 25, further comprising a preliminary step of verifying that the effectiveness of the source attribute for modalities in a given group for each target attribute is greater than the predetermined value, and if such is not the case, to implement a merge of said group with a specific group, said merged group then forming again said specific group.

27. A method of discretization in dimension k of a group of k continuous source attributes of a database containing a population of individuals, with the object in particular of predicting the modalities of a given target attribute, said method comprising the following steps of:
(a) partitioning of said modalities of the group of k source attributes into elementary regions of dimension k,
(b) evaluating for elementary regions of dimension k of the value of χ² of a contingence table after a possible merge of said elementary regions of dimension k,
(c) searching among the set of said elementary regions of dimension k that can be merged, for the elementary regions of dimension k whose merge would maximize the value of χ²,
(d) skipping directly to step f) as long as the value Δχ² of the variation of the value of χ² before and after merge is, in absolute value, less than a predetermined threshold value MaxΔχ²,
(e) stopping of the method if there is no set of intervals that make it possible to reduce a probability of independence, and
(f) otherwise merging and reiterating of steps b) to e).

28. A method of grouping in dimension k of a group of k discrete source attributes of a database containing a population of individuals, with the object in particular of predicting the modalities of a given target attribute, said method comprising the following steps of:
(a) partitioning of said modalities of the group of k source attributes into a plurality of groups,
(b) evaluating for each plurality of groups of the value of χ² of a contingence table after a possible merge of said plurality,
(c) searching, among the set of plurality of groups that can be merged, for the plurality of groups whose merge would maximize the value of χ²,
(d) skipping directly to step f) as long as the value Δχ² of the variation of the value of χ² before and after merge is, in an absolute value, less than a predetermined threshold value MaxΔχ²,
(e) stopping of the method if there is no set of intervals that make it possible to reduce a probability of independence, and
(f) otherwise merging and reiterating of steps b) to e).
